(19) United States
(12) Patent Application Publication
(10) Pub. No.: US 2019/0270332 A1
(43) Pub. Date: Sep. 5, 2019

(54) MULTILAYER SHEET MATERIAL IN THE FORM OF A PRINTING BLANKET OR OF A PRINTING PLATE

(71) Applicant: ContiTech Elastomer-Beschichtungen GmbH, Hannover (DE)

(72) Inventors: Jens Loeschner, Bovenden (DE); Torsten Raschdorf, Einbeck (DE); Markus Gnass, Hattorf am Harz (DE); Bjoern Heise, Goettingen (DE)

(73) Assignee: ContiTech Elastomer-Beschichtungen GmbH, Hannover (DE)

(21) Appl. No.: 16/276,640

(22) Filed: Feb. 15, 2019

(30) Foreign Application Priority Data
Feb. 19, 2018 (DE) 10 2018 202 492.8

(51) Int. Cl. B41N 10/04; B41N 1/12; B32B 25/04; B32B 25/14

(52) U.S. Cl. CPC B41N 10/04; B41N 1/12; B41N 2210/00; B32B 25/14; B32B 25/042

(57) ABSTRACT

The invention relates to a multilayer sheet material 10 in the form of a printing blanket or of a printing plate, in particular for the printing of conical or cylindrical vessels made of, for example, plastic, styropore, paperboard, metal, etc., with a multiple-ply printing layer 1,2 made of at least one polymeric material and at least one other layer 3, 4, where the individual layers form, with one another, an adhesive bond that is not amenable to non-destructive separation.

The upper ply 1 of the printing layer, which during the printing procedure faces toward the object to be printed, comprises from 40 to 80 phr of butadiene rubber (BR) and from 20 to 60 phr of butyl rubber (IIR), and the lower ply 2, which during the printing procedure faces away from the object to be printed, comprises from 80 to 100 phr of butyl rubber (IIR).

The invention relates to a multilayer sheet material in the form of a printing blanket or of a printing plate, in particular for the printing of conical or cylindrical vessels made of, for example, plastic, styropore, paperboard, metal, etc., with a multiple-ply printing layer made of at least one polymeric material and at least one other layer, where the individual layers form, with one another, an adhesive bond that is not amenable to non-destructive separation.

Printing blankets, as described by way of example in EP 0 191 779 B2, are multilayer sheet materials with a printing layer made of a polymeric material, at least one compressible or incompressible intervening layer, and at least one reinforcement layer consisting of a textile sheet material, where the individual layers form, with one another, an adhesive bond that is not amenable to non-destructive separation. The adhesive bond that is not amenable to non-destructive separation can be achieved via suitable selection of materials of the individual layers. Alternatively, the adhesive bond is achieved by way of a separate tie layer or by way of an adhesion promoter between the individual layers, see by way of example DE 20 2011 110 044 U1 or GB 680,337 A.

During the printing of conical or cylindrical vessels, printing blanket surfaces are subject to very high mechanical stress. The container is accelerated on contact with the printing blanket surface, and for any given rotation rate the conical configuration gives rise to surface velocity differences across the printing blanket surface. The surface is thus exposed to mechanical forces which are very high and exhibit local differences.

For the printing of conical or cylindrical pots, micro-ground offset printing blankets can be used; these have serious disadvantages in relation to wear and print quality. Their surface has a typical ground structure resulting from the grinding procedure used for thickness calibration. It is not possible to use other surfaces (e.g. smooth, embossed) that would be more suitable for said application.

The object underlying the invention is now to provide a multilayer sheet material which takes the form of a printing blanket or of a printing plate and which features improved print quality and improved wear performance in the printing of conical or cylindrical vessels.

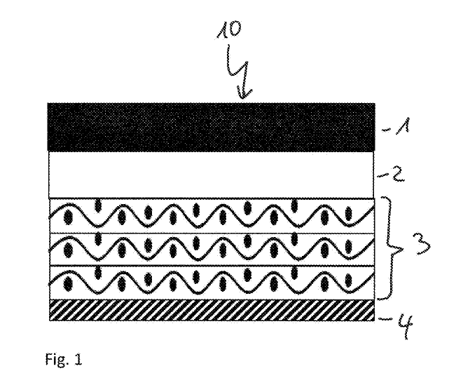

As a brief description of the drawing, FIG. 1 depicts a multilayer sheet material 10 in the form of a printing blanket or of a printing plate, according to the invention.

This object is achieved in that the multilayer sheet material of the type mentioned in the introduction comprises a multiple-ply printing layer where the upper ply, which during the printing procedure faces toward the object to printed, comprises from 40 to 80 phr of butadiene rubber (BR) and from 20 to 60 phr of butyl rubber (IIR), and the lower ply, which during the printing procedure faces away from the object to be printed, comprises from 80 to 100 phr of butyl rubber (IIR).

Surprisingly, it has been found that the multiple-ply, preferably two-ply, design of the printing layer results in optimized properties for the use of the multilayer sheet material.

The lower ply of the printing layer comprises from 80 to 100 phr, preferably from 90 to 100 phr, very particularly preferably 100 phr, of butyl rubber (IIR). This IIR exhibits high stiffness under dynamic loading. This provides ideal transfer of ink to the substrate.

The upper ply of the printing layer comprises from 40 to 80 phr, preferably from 60 to 80 phr, of butadiene rubber (BR), and from 20 to 60 phr, preferably from 20 to 40 phr, of butyl rubber (IIR). The IIR content results in ideal bonding to the base. The BR content here provides very high wear resistance, i.e. optimized abrasion performance.

BR moreover has very high elasticity, and the surface of the printing blanket can therefore undergo elastic deformation during impingement on the printing blanket surface. The compression set of the upper ply of the printing layer is moreover sufficiently small to avoid any residual deformation, in particular due to the pot edges that are sometimes present.

In a particularly preferred embodiment here, the upper ply of the printing layer can have been embossed, thus having a smooth, velvet-like surface structure which provides homogeneous ink transfer specifically on smooth surfaces.

The lower ply and the upper ply comprise not only the rubbers mentioned but also other ingredients. These other ingredients are generally crosslinking agents or a crosslinking agent system (crosslinking agent and accelerator), fillers and/or processing aids and/or plasticizers and/or aging inhibitors, and also optionally other additives (e.g. color pigments). Reference is made in this connection to the general art of rubber mixing technology.

In a particularly preferred embodiment, the printing layer consists of two plies, namely the lower ply mentioned and the upper ply mentioned. Both plies are preferably also in direct contact with one another, i.e. without any additional ply therebetween.

According to the invention, the multiple-ply sheet material comprises at least one other layer. This is preferably a reinforcement layer, which can be of single-ply or multiple-ply configuration.

The reinforcement layer is preferably of multiple-ply configuration, consisting of two or three plies, which can be identical or different from one another.

It is preferable that each of the individual plies within the reinforcement layer here is a woven fabric consisting of warp filaments and weft filaments.

The material for the warp filaments and/or the weft filaments is preferably selected from the group consisting of polyester and/or polyoxadiazole (POD) and/or polyetherimide (PEI) and/or m-aramid and/or p-aramid and/or metal and/or glass and/or ceramic and/or stone and/or carbon and/or modified polyester (mod PES) and/or modified viscose and/or polyamide (PA), e.g. PA6, PA6.6, PA11, PA12, PA6.10, PA6.12, and/or copolyamides and/or polyesters (PES) having relatively high melting points and/or rayon and/or polyethylene terephthalate (PET) and/or cotton and/or spun rayon and/or polyvinyl alcohol (PVAL) and/or polyvinyl acetal (PVA) and/or polyetheretherketone (PEEK) and/or polyethylene 2,6-naphthalate (PEN) and/or polyphenylene and/or polyphenylene oxide (PPO) and/or polyphenylene sulfide (PPS) and/or polyphenylene ether and/or polybenzoxazole (PBO). The materials mentioned can be used here alone or in combination with at least one other material in the form of hybrid. It is particularly preferable to use cotton, because it has low and stable extensibility.

The other layer present according to the invention in the multiple-ply sheet material can likewise be an additional layer preferably composed of at least one polymeric material. The polymeric material here can be an elastomeric material based on a vulcanized rubber mixture which comprises an unblended rubber component or comprises a rubber-component blend, and comprises conventional mixture ingredients. Rubber components that may be mentioned are in particular: Ethylene-propylene copolymer (EPM) and/or ethylene-propylene-diene copolymer (EPDM) and/or nitrile rubber (NBR) and/or (partially) hydrogenated nitrile rubber (HNBR) and/or fluoro rubber (FKM) and/or chloroprene rubber (CR) and/or natural rubber (NR) and/or styrene-butadiene rubber (SBR) and/or isoprene rubber (IR) and/or butyl rubber (IIR) and/or bromobutyl rubber (BIIR) and/or chlorobutyl rubber (CIIR) and/or butadiene rubber (BR) and/or chlorinated polyethylene (CM) and/or chlorosulfonated polyethylene (CSM) and/or polyepichlorohydrin (ECO) and/or ethylene-vinyl acetate rubber (EVA) and/or acrylate rubber (ACM) and/or ethylene-acrylate rubber (AEM) and/or silicone rubber (MQ, VMQ, PVMQ, FVMQ) and/or fluorinated methylsilicone rubber (MFQ) and/or perfluorinated propylene rubber (FFPM) and/or perfluorocarbon rubber (FFKM) and/or polyurethane (PU).

It is also possible to use a blend, in particular in combination with one of the abovementioned rubbers, an example being an NR/BR blend.

The following are of particular importance, especially for printing blankets: HNBR, EPDM, NBR.

The usual mixture ingredients comprise at least one crosslinking agent or one crosslinking agent system (crosslinking agent and accelerator). Other additional mixture ingredients are mostly a filler and/or a processing aid and/or a plasticizer and/or an aging inhibitor, and also optionally other additives (e.g. color pigments). Reference is made in this connection to the general art of rubber mixture technology.

If the additional layer is a compressible layer, the rubber mixture additionally comprises blowing agents and/or hollow microspheres in order to form pores for good compressibility.

The multilayer sheet material can therefore preferably consist of a multiple-ply printing layer and a reinforcement layer, or of a multiple-ply printing layer and a compressible layer, or of a multiple-ply printing layer and a reinforcement layer and a compressible layer.

The multilayer sheet material of the invention in the form of a printing blanket or of a printing plate can equally be configured as flexible container, protective suit, liferaft material, hose, airspring bellows, drive belt, conveyor belt or folding bellows. However, it is preferable that the multilayer sheet material is a printing blanket of the type in particular required for the printing of conical and cylindrical vessels.

### LIST OF REFERENCE SIGNS

### Part of the Description

10 Printing blanket

1 Upper ply of printing layer

2 Lower ply of printing layer

3 Multiple-ply reinforcement layer

4 Additional layer made of polymeric material

1.-5. (canceled)

6. A multilayer sheet material comprising a multiple-ply printing layer made of at least one polymeric material and at least one other layer, wherein individual layers forming the multiple-ply printing layer have an adhesive bond therebetween, wherein an upper ply of the multiple-ply printing layer faces toward an object to be printed, and comprises from 40 to 80 phr of butadiene rubber and 20 to 60 phr of butyl rubber, and a lower ply of the multiple-ply printing layer faces away from the object to be printed, and comprises from 80 to 100 phr of butyl rubber;
wherein the multilayer sheet material is in the form of a printing blanket or of a printing plate; and,
provided the adhesive bond is not amenable to non-destructive separation

7. The multilayer sheet material as claimed in claim 5, wherein the upper ply comprises from 60 to 80 phr of butadiene rubber and from 20 to 40 phr of butyl rubber.

8. The multilayer sheet material as claimed in claim 5, wherein the lower ply comprises 100 phr of butyl rubber.

9. The multilayer sheet material as claimed in claim 5, wherein the multiple-ply printing layer consists essentially of the lower ply and the upper ply.

10. The multilayer sheet material as claimed in claim 9, wherein the lower ply and the upper ply are in direct contact with one another with no additional intervening ply.

11. The multilayer sheet material as claimed in claim 9, wherein the upper ply has an embossed and smooth surface structure which provides homogeneous ink transfer onto smooth surfaces.

12. The multilayer sheet material as claimed in claim 5 further comprising a multiple-ply reinforcement layer.

13. The multilayer sheet material as claimed in claim 12, wherein the multiple-ply reinforcement layer is disposed on an opposing side of the lower ply from the upper ply.

14. The multilayer sheet material as claimed in claim 13, wherein the multiple-ply reinforcement layer comprises individual plies, and wherein each of the individual plies consists of warp filaments and weft filaments.

15. The multilayer sheet material as claimed in claim 12 further comprising an additional layer comprising a polymeric material, and wherein the additional layer is disposed on an opposing side of the multiple-ply reinforcement layer from the lower ply.

16. A printing blanket comprising a multilayer sheet material, wherein the multilayer sheet material comprises a multiple-ply printing layer made of at least one polymeric material and at least one other layer, wherein individual layers forming the multiple-ply printing layer have an adhesive bond therebetween, wherein an upper ply of the multiple-ply printing layer faces toward an object to be printed, and comprises from 40 to 80 phr of butadiene rubber and 20 to 60 phr of butyl rubber, and a lower ply of the multiple-ply printing layer faces away from the object to be printed, and comprises from 80 to 100 phr of butyl rubber; and,
provided the adhesive bond is not amenable to non-destructive separation

17. The printing blanket as claimed in claim 16, wherein the upper ply comprises from 60 to 80 phr of butadiene rubber and from 20 to 40 phr of butyl rubber.

18. The printing blanket as claimed in claim 16, wherein the lower ply comprises 100 phr of butyl rubber.

19. The printing blanket as claimed in claim 16, wherein the multiple-ply printing layer consists essentially of the lower ply and the upper ply.

20. The printing blanket as claimed in claim 19, wherein the lower ply and the upper ply are in direct contact with one another with no additional intervening ply.

21. The printing blanket as claimed in claim 19, wherein the upper ply has an embossed and smooth surface structure which provides homogeneous ink transfer onto smooth surfaces.

22. The printing blanket as claimed in claim 16, wherein the multilayer sheet material further comprises a multiple-ply reinforcement layer.

23. The printing blanket as claimed in claim 22, wherein the multiple-ply reinforcement layer is disposed on an opposing side of the lower ply from the upper ply.

24. The printing blanket as claimed in claim 23, wherein the multiple-ply reinforcement layer comprises individual plies, and wherein each of the individual plies consists of warp filaments and weft filaments.

25. The printing blanket as claimed in claim 22, wherein the multilayer sheet material further comprises an additional layer comprising a polymeric material, and wherein the additional layer is disposed on an opposing side of the multiple-ply reinforcement layer from the lower ply.
